(19) United States
(12) Patent Application Publication
(10) Pub. No.: US 2026/0347646 A1
(43) Pub. Date: Nov. 5, 2026

(54) MICHAEL ADDITION CURABLE COMPOSITION, ITS APPLICATION AND PROCESS FOR PREPARING MODIFIED EPOXY RESIN SUITABLE FOR THE SAME

(71) Applicant: GUANGDONG HUARUN PAINTS CO., LTD., Foshan (CN)

(72) Inventors: Song NIU, Foshan (CN); Weichuan CHEN, Foshan (CN)

(21) Appl. No.: 19/099,194

(22) PCT Filed: Aug. 23, 2023
(86) PCT No.: PCT/CN2023/114532

§ 371 Date: Jan. 28, 2025

(30) Foreign Application Priority Data
Aug. 25, 2022 (CN) 202211030044.X

(51) Int. Cl. C09D 165/00; C08G 59/14; C08G 61/12; C09D 7/20

(52) U.S. Cl. CPC C09D 165/00; C08G 59/1438; C08G 61/12; C09D 7/20; C08G 2261/124; C08G 2261/334; C08G 2261/354; C08G 2261/42

(57) ABSTRACT

The present application relates to a Michael Addition curable composition, and its application as well as a process for preparing modified epoxy resin suitable for the above composition. In particular, the Michael Addition curable composition, comprises at least one reactive donor capable of providing two or more nucleophilic carbanions; at least one reactive acceptor comprising two or more carbon-carbon double bonds; and at least one catalyst for catalyzing a Michael Addition crosslinking reaction between the at least one reactive donor and the at least one reactive acceptor, wherein the at least one reactive donor comprises at least one epoxy resin-based reactive donor derived from at least one epoxy resin; and wherein the at least one epoxy resin-based reactive donor comprises at least one first —C(O)—CH₂—C(O)-moiety and at least one second —C(O)—CH₂—C(O)-moiety, in which the at least one first —C(O)—CH₂—C(O)-moiety is covalently incorporated into at least one epoxy resin backbone, and the at least one second —C(O)—CH₂—C(O)-moiety is covalently bonded to pendant chains on the at least one epoxy resin backbone.

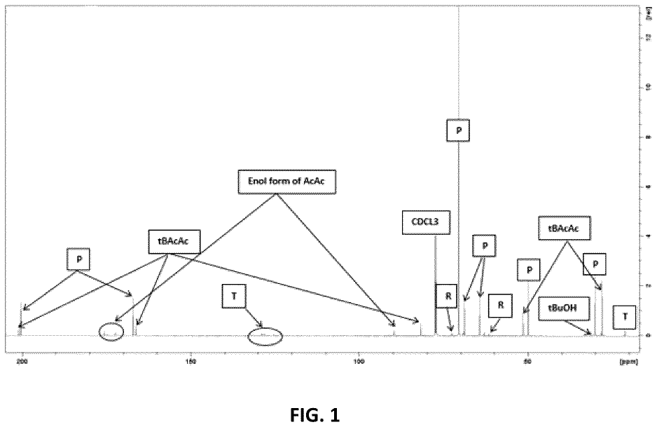

### TECHNICAL FIELD

The present application relates to a curable composition. More specifically, the present application relates to a Michael Addition curable composition and its application, involving a coating composition containing the composition and a coated article made therefrom. The present application further relates to a process for preparing modified epoxy resin suitable for the above composition.

### BACKGROUND

Due to increasingly strict environmental regulations, the standards for free diisocyanates (such as toluene diisocyanate TDI) and volatile organic compound (VOC) emission in industrial applications have become more and more stringent as free TDI is extremely harmful to human body and environment protection. Therefore the technology on non-isocyanate (NICN) curing without any free TDI has gained great attention in academic and industrial fields.

Up to date, there have being several potentially curable methods by NICN in industrial applications, for example including a polycarbodiimide (PCDI) curing system, a Michael Addition curing system and so on. The PCDI curing system, however, is hardly commercialized on account of its short pot-life at this stage. Currently, the Michael Addition curing system has been widely applied in industry fields. Meanwhile, this Michael Addition curing system has many attractive advantages, including: (1) capable of curing at ambient temperatures, even lower temperature; (2) very low solvent content such as VOC <250 g/l; (3) very long pot-life such as a pot life of >8 hours at 23 °C; (4) excellent appearance such as gloss@600 of >90 and DOI >90; (5) capable of applying at a thick layer, such as with as a thickness of >150 μm; (6) very good chemical resistance; (7) excellent toughness; (8) good outdoor durability; (9) free of isocyanate; formaldehyde and organotin. Thus, there has been a strong demand for this Michael Addition curing system in market.

In terms of composition, a Michael addition curing system is usually composed of a reactive donor, a reactive acceptor, a catalyst for catalyzing the Michael addition crosslinking reaction between the reactive donor and the reactive acceptor, and other additional components. At present, the research on this curing system mainly focuses on the catalyst and the additional components, and the research on the reactive donor and reactive acceptor is very limited. In the disclosed Michael addition curing systems, reactive functional groups of the reactive donor and reactive acceptor are mostly of a single type, and thus the Michael addition curing system formulated therefrom tends to have a single performance, which cannot meet the growing market requirements for the performance of coating compositions, especially curing performance and coating performance.

Therefore, there is a need in industry for an improved Michael Addition curable system.

### SUMMARY

In one aspect, the present application discloses a Michael Addition curable composition, comprising:
at least one reactive donor capable of providing two or more nucleophilic carbanions;
at least one reactive acceptor comprising two or more carbon-carbon double bonds; and
at least one catalyst for catalyzing a Michael Addition crosslinking reaction between the at least one reactive donor and the at least one reactive acceptor,
wherein the at least one reactive donor comprises at least one epoxy resin-based reactive donor derived from at least one epoxy resin; and
wherein the at least one epoxy resin-based reactive donor comprises at least one first —C(O)—CH₂—C(O)— moiety and at least one second —C(O)—CH₂—C(O)— moiety, in which the at least one first —C(O)—CH₂—C(O)-moiety is covalently incorporated into at least one epoxy resin backbone, and the at least one second —C(O)—CH₂—C(O)-moiety is covalently bonded to pendant chains on the at least one epoxy resin backbone. Preferably, a molar ratio of the at least one first —C(O)—CH₂—C(O)-moiety covalently incorporated into the at least one epoxy resin backbone to the at least one second —C(O)—CH₂—C(O)-moiety covalently bonded to pendant chains on the at least one epoxy resin backbone is less than 1:1 but greater than 1:4, preferably in the range of 1:1.5-2.5, more preferably in the range of 1:1.8-2.2.

In an embodiments of the present application, the at least one epoxy resin-based reactive donor is obtained by:
(i) subjecting at least one epoxy resin to a ring-opening reaction with malonic acid at a temperature below 130 °C, preferably in the range of 90 °C to 120 °C in the presence of at least one catalyst to reach an acid value close to 0 mg KOH/g, thereby introducing secondary hydroxyl groups into the at least one epoxy resin, to form a reaction product; and
(ii) subjecting the reaction product obtained in step i) to a transesterification reaction with at least one alkyl acetoacetate to form the at least one epoxy resin-based reactive donor.

In some embodiments of the present application, the Michael Addition curable composition may be used for manufacture of coatings, adhesives, sealing agents, foaming materials, films, molded products or inks.

In another aspect, the present application provides a coating composition, comprising the Michael Addition curable composition according to the present application. In some embodiments of the present application, when the coating composition is applied at a wet coat thickness of 200 microns and dried for 1 day, the resulting cured coating has a chemical resistance of grade 4 or more, preferably of grade 5, as determined by ASTM F2250-method B.

In another aspect, the present application provides a coated article comprising a substrate having at least one major surface; and a cured coating at least of which is formed from the coating composition of the present application directly or indirectly applied on the major surface. Preferably, the substrate comprises wood, metal, plastic, ceramic, cementitious board, glass or any combination thereof.

In another aspect, the present application provides a process for preparing a modified epoxy resin comprising the steps of: (i) subjecting at least one epoxy resin to a ring-opening reaction with malonic acid at a temperature below 130 °C, in the presence of at least one catalyst, so as to reach an acid value close to 0 mg KOH/g, thereby introducing secondary hydroxyl groups into the at least one epoxy resin, to form a reaction product; and (ii) subjecting the reaction product obtained in step i) to a transesterification reaction with at least one alkyl acetoacetate to form the modified epoxy resin, wherein the modified epoxy resin comprises at least one first —C(O)—CH₂—C(O)— moiety and at least one second —C(O)—CH₂—C(O)— moiety, in which the at least one first —C(O)—CH₂—C(O)-moiety is covalently incorporated into at least one epoxy resin backbone, and the at least one second —C(O)—CH₂—C(O)-moiety is covalently bonded to pendant chains on the at least one epoxy resin backbone. In some embodiments of the present application, the catalyst is selected from quaternary ammonium salts, quaternary phosphonium salts, or combinations thereof, preferably tetraalkylammonium bromides.

In the present invention, the applicant has successfully synthesized modified epoxy resins having two or more —C(O)—CH₂—C(O)-moieties, wherein one of said two or more —C(O)—CH₂—C(O)-moieties is covalently bonded into said epoxy resin skeleton, and wherein another of said two or more —C(O)—CH₂—C(O)-moieties is covalently bonded to pendent chains on said epoxy resin skeleton, and has successfully applied them as a reactive donor for a Michael addition curing system. This modified epoxy resin has a higher active hydrogen density and an appropriate polydispersity index, making it suitable for use as a reactive donor for a Michael addition curing system, and when the Michael addition curing system formulated therefrom is cured, the resulting coating shows a significantly better chemical resistance. The acquisition of polymers with this new structure expands the window of reactive donors for the Michael addition curable compositions, and enhances the application prospects of the Michael addition curing system.

The details of one or more embodiments of the invention are set forth in the description below. Other features, objects, and advantages of the invention will be apparent from the description, and from the claims.

### DEFINITION

As used herein, “a”, “an”, “the”, “at least one”, and “one or more” are used interchangeably. Thus, for example, a coating composition that comprises “an” additive can be interpreted to mean that the coating composition includes “one or more” additives.

Throughout the present application, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in this invention, as along as such components or steps do not affect the basic and novel characteristics of the invention, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the term “Michael Addition” refers to the nucleophilic addition of a carbanion provided by a reactive donor to an electrophilic conjugated system such as carbon-carbon double bond of a reactive acceptor. A Michael Addition reaction follows the general reaction schematic shown here:

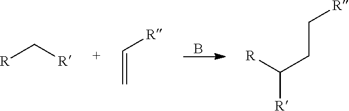

In the reaction schematic shown above, substituents R and R′ on the reactive donor are electron-withdrawing groups, so that the hydrogen on methylene of the reactive donor can be deprotonated and form a carbanion in the presence of a catalyst B; and the reactive acceptors usually comprise α, β-unsaturated ketones, aldehydes, carboxylic acids, esters, nitriles, nitro and other compounds.

The term “nucleophilic carbanion” in the context of “a reactive donor”, refers to an active intermediate of carbon with a lone pair of electrons to which two or three strong electronegative groups are attached. The strong electronegative groups may include, but not limited to, —NO₂, —C(═O)—, —CO₂R₁, —SO₂—, —CHO, —CN, and —CONR₂, and the like, wherein R₁ and R₂ each independently represent an alkyl group. In some embodiments of the present application, the nucleophilic carbanion is derived from an acidic proton C—H in activated methylene or methine group.

The term “carbon-carbon double bond” in the context of “a reactive acceptor”, refers to a structure containing a carbon-carbon double bond in its molecule, excluding a benzene ring. Examples of a carbon-carbon double bond include, but are not limited to, —C═C—C═C—, —C═C—C≡C—, —C═C—CHO, —C═C—CO—, —C═C—C(O)O—, —C═C—CN.

As used herein, the term “epoxy resin-based reactive donor” refers to a reactive donor derived from an epoxy resin, which is capable of providing two or more nucleophilic carbanions.

The term “aromatic epoxy backbone” in the context of “epoxy resin-based reactive donor” refers to a backbone structure derived from an epoxy resin having a closed aromatic ring or ring system therein, which closed aromatic ring or ring system is rigid, unlike flexible alkyl or cycloalkyl groups such as cyclohexyl. Examples of such aromatic ring structures include, but not limited to, phenylene, naphthylene, biphenylene, fluorenylene, and indenyl, as well as heteroarylenes (e.g., closed aromatic or aromatic cyclic hydrocarbon or ring system in which one or more atoms in the ring is an element other than carbon such as nitrogen, oxygen, sulfur, etc.).

The term “ether oxygen bond (—O—)” in the context of “epoxy resin-based reactive donor” means a flexible ether bond having a structure —CH₂—O—C₆H₄— present in the backbone structure of the epoxy resin.

The term “epoxy equivalent” (EEW) in the context of “epoxy resin-based reactive donor”, refers to a mass of the reactive donor containing 1 mol of epoxy group. Generally, the lower the EEW, the more the epoxy group contained in the reactive donor is and the higher the reactivity is.

The term “glass transition temperature (Tg)” in the context of “epoxy resin-based reactive donor”, refers to a glass transition temperature of the said reactive donor itself, which is determined, for example, by differential scanning calorimetry using ASTM D6604-00.

The term “—C(O)—CH₂—C(O)-moiety equivalent” in the context of “epoxy resin-based reactive donor”, refers to a resin mass containing 1 mol of —C(O)—CH₂—C(O)-moiety. The higher the equivalent, the lower the content of active hydrogen functional groups is; and the lower the equivalent, the higher the content of active hydrogen functional groups is. In an embodiment of the present application, “—C(O)—CH₂—C(O)-moiety equivalent” is calculated by subtracting the small molecular species produced by the reaction from all raw materials used for the preparation of resin, including but not limited to “water” and “alcohols” to obtain the total mass of resin, and then calculating the mass of resin containing 1 mol of —C(O)—CH₂—C(O)-moiety based on the molar amount of raw materials containing —C(O)—CH₂—C(O)-moiety, i.e. the —C(O)—CH₂—C(O)-moiety equivalent of the resulting resin.

The term “glass transition temperature (Tg)” in the context of “reactive acceptor”, refers to a glass transition temperature of a homopolymer formed from the reactive acceptor molecule by homopolymerization, which is determined, for example, by differential scanning calorimetry using ASTM D6604-00.

The term “substantially free” of certain component in the context of “coating composition” means that the coating composition of the present application contains no more than 0.1% by weight, preferably no more than 0.05% by weight, more preferably not more than 0.010% by weight of said components based on the total weight of the coating composition.

As used in “Michael addition curable composition”, the term “tack-free time” means that the time required for the resulting coating as obtained by mixing the components of the composition at a specific temperature to form a mixture and applying the mixture to the test substrate in a specific wet coating thickness (for example, 100 μm) to reach not to stick hands, for example, by touching. In some embodiments, the track free time can also be tested by other methods known in the art.

As used in “Michael addition curable composition”, the term “gel time” refers to the time required for the resulting mixture as obtained by mixing the components of the composition at a specific temperature to reach a non-flowable gel state. In an embodiment of the present application, the gel time is a parameter used to measure constructability of the Michael addition curable composition.

The term “main surface”, when used in the context of a substrate, refers to a surface formed by certain lengthwise and widthwise dimensions of the substrate for providing decoration.

The term “on”, when used in the context of a coating composition applied on a main surface of substrate, includes the coating composition applied directly or indirectly to the main surface of substrate. In some embodiments of the present application, the coating composition according to the present application is applied directly to a main surface of substrate to form a coating. In some embodiments of the present application, there be one or more barrier layers or adhesion promoting layers between the coating composition according to the invention and substrate.

The term “comprises”, “comprising”, “contains” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

### DETAILED DESCRIPTION

The present embodiments in one aspect disclose a Michael Addition curable composition, comprising:
at least one reactive donor capable of providing two or more nucleophilic carbanions;
at least one reactive acceptor comprising two or more carbon-carbon double bonds; and
at least one catalyst for catalyzing a Michael Addition crosslinking reaction between the at least one reactive donor and the at least one reactive acceptor,
wherein the at least one reactive donor comprises at least one epoxy resin-based reactive donor derived from at least one epoxy resin; and
wherein the at least one epoxy resin-based reactive donor comprises at least one first —C(O)—CH₂—C(O)— moiety and at least one second —C(O)—CH₂—C(O)— moiety, in which the at least one first —C(O)—CH₂—C(O)-moiety is covalently incorporated into at least one epoxy resin backbone, and the at least one second —C(O)—CH₂—C(O)-moiety is covalently bonded to pendant chains on the at least one epoxy resin backbone. Preferably, a molar ratio of the at least one first —C(O)—CH₂—C(O)-moiety covalently incorporated into the at least one epoxy resin backbone to the at least one second —C(O)—CH₂—C(O)-moiety covalently bonded to pendant chains on the at least one epoxy resin backbone is less than 1:1 but greater than 1:4, preferably in the range of 1:1.5-2.5, more preferably in the range of 1:1.8-2.2.

### Reactive Donor

According to embodiments of the present invention, Michael Addition curable composition, comprises at least one reactive donor capable of providing two or more nucleophilic carbanions. As described above, the nucleophilic carbanion refers to an active intermediate of carbon with a lone pair of electrons to which two or three strong electronegative groups are typically attached. As an example of the strong electronegative groups, it may be one or more selected from —NO₂, —C(═O)—, —CO₂R₁, —SO₂—, —CHO, —CN, and —CONR₂, and the like, wherein R₁ and R₂ each independently represent an alkyl group.

In an embodiment of the present application, the reactive donor comprises at least one epoxy resin-based reactive donor. The reactive donor is derived from an epoxy resin and further comprises two or more —C(O)—CH₂—C(O)— moieties, to provide nucleophilic carbanions so as to function as a reactive donor. It was surprisingly found by the inventors of the present application that the Michael addition curable system composed of this reactive donor has an adjustable curing speed, for example, its tack-free time can be controlled within an appropriate time period, for example, within 1.5 hours, and that the resulting coating formed therefrom has a significantly better chemical resistance.

According to an embodiment of the present invention, an epoxy resin-based reactive donor refers to a reactive donor derived from an epoxy resin, such epoxy resin-based reactive donor comprising two or more —C(O)—CH₂—C(O)— moieties. As mentioned above, in the currently existing Michael addition curable system, reactive functional groups of the reactive donor are mostly of a single type, and thus the Michael addition curable system formulated therefrom tends to have a single performance, which cannot meet the growing market requirements for the performance of coating compositions, especially curing performance and coating performance. It was surprisingly found by the inventors of the present application that incorporation of two or more —C(O)—CH₂—C(O)-moieties into the epoxy resin-based reactive donor according to the present invention, wherein one of said two or more —C(O)—CH₂—C(O)-moieties is covalently bonded to said epoxy resin backbone and wherein another one of said two or more —C(O)—CH₂—C(O)-moieties is covalently bonded to pendent chains of said epoxy resin backbone, may enable the Michael addition curable system formulated therefrom to have significantly improved curing properties, such as a significantly increased pot life.

In a specific embodiment according to the present invention, said —C(O)—CH₂—C(O)-moiety covalently bonded to said epoxy resin backbone may be derived from malonic acid and said —C(O)—CH₂—C(O)-moiety covalently bonded to pendent chains on said epoxy resin backbone may be derived from alkyl acetoacetates. Since the —C(O)—CH₂—C(O)-moiety derived from malonic acid has a different reactivity than the —C(O)—CH₂—C(O)-moiety derived from alkyl acetoacetates, the epoxy resin-based reactive donor comprising the above-described —C(O)—CH₂—C(O)-moieties both has a tunable reactivity, and subsequently, the Michael addition curable system formulated therefrom have a controllable curing rate, which is of great significance to the coatings industry.

In some embodiments according to the present invention, two or more —C(O)—CH₂—C(O)-moieties contained in said epoxy resin-based reactive donor may have a particular molar ratio, wherein the —C(O)—CH₂—C(O)-moiety covalently bonded to said epoxy resin skeleton is more predominant in the combination of the —C(O)—CH₂—C(O)-moiety covalently bonded to pendent chains on said epoxy resin skeleton and the —C(O)—CH₂—C(O)-moiety covalently bonded to said epoxy resin skeleton. That is to say, the —C(O)—CH₂—C(O)-moiety covalently bonded into said epoxy resin skeleton is not overwhelmingly predominant, but its content is significant as a proportion of the sum of the —C(O)—CH₂—C(O)-moiety covalently bonded to pendent chains on said epoxy resin skeleton and the —C(O)—CH₂—C(O)-moiety covalently bonded to said epoxy resin skeleton i.e. at least 20%. Specifically, in at least one epoxy resin-based reactive donor according to an embodiment of the present invention, a molar ratio of the at least one first —C(O)—CH₂—C(O)-moiety covalently incorporated into the at least one epoxy resin backbone to the at least one second —C(O)—CH₂—C(O)-moiety covalently bonded to pendant chains on the at least one epoxy resin backbone is less than 1:1 but greater than 1:4, preferably in the range of 1:1.5-2.5, more preferably in the range of 1:1.8-2.2.

If the proportion of —C(O)—CH₂—C(O)-moiety covalently bonded to pendent chains on said epoxy resin skeleton in the resulting epoxy resin-based reactive donor is too large, the Michael addition curable composition formulated therefrom has a too fast curing speed and too short pot life and thus it is difficult to be constructed. If the proportion of —C(O)—CH₂—C(O)-moiety covalently bonded to the epoxy resin skeleton in the resulting epoxy resin-based reactive donor is too large, the Michael addition curable composition formulated therefrom has a too long curing period and thus its economic efficiency is worse.

According to an embodiment of the present invention, as described above, the epoxy resin-based reactive donor is a reactive donor derived from an epoxy resin. Specifically, said epoxy resin-based reactive donor may be derived from an aromatic epoxy resin, which may comprise at least one aromatic epoxy backbone. Preferably, said aromatic epoxy backbone is derived from a bisphenol A epoxy resin, a bisphenol F epoxy resin, a novolac resin and mixtures or combinations thereof. Suitable aromatic epoxy resins that may be functionalized to act as a reactive donor include, but are not limited to, bisphenol A epoxy resins, bisphenol F epoxy resins, and novolac epoxy resins. As noted above, an aromatic structure in the epoxy backbone of the reactive donor has a rigid structure. It was surprisingly found by the inventors of the present invention that introduction of an aryl or aryl ring system having a rigid structure in the epoxy backbone of the reactive donor can provide a cured coating with improved hardness as compared to a Michael addition cured coating having a flexible alkyl or cycloalkyl group.

According to an embodiment of the present invention, the epoxy resin-based reactive donor may further comprise at least one ether oxygen bond (—O—). As described above, the ether oxygen bond in the epoxy resin-based reactive donor are flexible. It was surprisingly found by the inventors of the present invention that the introduction of ether oxygen bond with flexibility into the epoxy backbone of the reactive donor can provide a cured coating with improved toughness.

It is known that in the field of synthesis, a method of functionalizing a resin to form a reactive donor suitable for a Michael Addition curable system usually includes esterifying a resin having a hydroxyl group with alkyl acetoacetates or dialkyl malonates. However, it is impossible to form a modified resin containing two or more —C(O)—CH₂—C(O)-moieties by the above method, much less to control a molar ratio of different kinds of —C(O)—CH₂—C(O)-moiety. The inventors of the present application provide a novel method for synthesizing a reactive donor such that the two or more —C(O)—CH₂—C(O)-moieties contained in the as prepared epoxy resin-based reactive donor have a specific molar ratio, and thus can be satisfied for industrial applications.

In a specific embodiment of the present invention, said at least one epoxy resin-based reactive donor is obtained by (i) subjecting at least one epoxy resin to a ring-opening reaction with malonic acid at a temperature below 130 °C, in the presence of at least one catalyst to reach an acid value close to 0 mg KOH/g, thereby introducing secondary hydroxyl groups into the at least one epoxy resin, to form a reaction product; and (ii) subjecting the reaction product obtained in step i) to a transesterification reaction with at least one alkyl acetoacetate to form the at least one epoxy resin-based reactive donor. Preferably, said at least one alkyl acetoacetate comprises at least one C1-C8 alkyl acetoacetate.

It was surprisingly found by the inventors of the present invention that, with the method described above, the —C(O)—CH₂—C(O)-moiety can be incorporated not only into the backbone structure of the epoxy resin, but also into the pendent chains on the backbone of the epoxy resin. The epoxy resin of this structure was first successfully synthesized by the inventors of the present application and successfully applied it in a Michael addition curable system. Prior to the present application, there is no prior art disclosing and teaching this novel epoxy resin and its application in a Michael addition curable system. Accordingly, this novel epoxy resin according to embodiments of the present invention expands the window for a reactive donor of a Michael addition curable composition and broadens the application range of a Michael addition curable composition. Moreover, it was surprisingly found by the inventors of the present invention that density of the —C(O)—CH₂—C(O)-moiety in the epoxy resin-based reactive donor as prepared by the above method is significantly increased. At the same time, the above method is more controllable than a method of esterifying hydroxyl groups of an epoxy resin with alkyl acetoacetates and/or dialkyl malonates, and thus the modified epoxy resins obtained therefrom have an appropriate and also narrower polydispersity index. Accordingly, the modified epoxy resin obtained by the method described above, when used as a reactive donor for a Michael addition curable system, can significantly increase a crosslink density of the resulting coating, and thus improve chemical resistance of the resulting coating.

In the embodiment according to the present invention, the at least one epoxy resin-based reactive donor has a polydispersity index in the range of 1.0 to 3.5, preferably in the range of 1.0 to 3.2, more preferably in the range of 1.1 to 3.0, as determined by gas permeation chromatography (GPC). Furthermore, in an embodiment according to the present invention, the at least one epoxy resin-based reactive donor has a weight average molecular weight in the range of 500 g/mol to 15000 g/mol, preferably in the range of 500 g/mol to 10000 g/mol, more preferably in the range of 500 g/mol to 8000 g/mol and even more preferably in the range of 500 g/mol to 5000 g/mol, as determined by GPC.

According to an embodiment of the present invention, the epoxy resin-based reactive donor may have a specific epoxy equivalent. It was surprisingly found by the inventors of the present invention that the epoxy equivalent of the epoxy resin based reactive donor is directly related to the content of VOC of its coating composition, which was not recognized prior to this application. Not being bound by any theory, the inventors assume that the reason may be the fact that an epoxy equivalent of an epoxy resin is correlated with its viscosity, with a higher epoxy equivalent corresponding to a higher resin viscosity. Thus, an epoxy resin having a lower epoxy equivalent can form films better with the assistance of smaller solvents and therefore result in less emission of VOC. According to an embodiment of the present invention, said epoxy resin-based reactive donor may have an epoxy equivalent in the range of 400-1100 g/mol, preferably in the range of 470-1000 g/mol, more preferably in the range of 470-900 g/mol, and still more preferably in the range of 560-885 g/mol.

According to an embodiment of the present invention, said epoxy resin-based reactive donor may have a relatively high glass transition temperature. It was surprisingly found by the inventors of the present invention that increasing a glass transition temperature of an epoxy resin based reactive donor is advantageous for increasing a hardness of the resulting cured coating formed therefrom. In one embodiment of the present invention, said epoxy resin based reactive donor has a glass transition temperature of 25 °C or higher. In view of practical applications, the glass transition temperature of the epoxy resin-based reactive donor should not be too high, as otherwise curing of the coating will be negatively affected and unwanted VOC emissions will occur. Therefore, it is preferred that the epoxy resin-based reactive donor according to the present invention has a glass transition temperature in the range of 25 °C to 40 °C.

The amount of the epoxy resin-based reactive donor used as the reactive donor in the Michael additive curable composition according to the present invention can be varied over a wide range as desired. In some embodiments of the present invention, the Michael additive curing composition comprises, relative to the total weight of a primary agent (comprising other remaining components than a catalyst and a diluent) of the Michael addition curable composition, 48 to 80 wt % of the epoxy resin-based reactive donor as a reactive donor, preferably 49 to 70 wt % of the epoxy resin-based reactive donor as a reactive donor.

### Reactive Acceptor

According to embodiments of the present application, the Michael Addition curable composition comprises a reactive acceptor containing two or more carbon-carbon double bonds.

According to embodiments of the present application, the reactive receptors have a relatively low molecular weight and are generally present in non-polymeric form. Preferably, the reactive acceptors have a molar mass of 1000 g/mol or lower, preferably 500 g/mol or lower, more preferably 350 g/mol or lower.

According to an embodiment of the present application, the carbon-carbon double bond group contained in the reactive acceptor has a structure represented by the following formula I:

C═C—CX (Formula I)

in which, CX represents any one of alkenyl group, alkynyl group, aldehyde group (—CHO), ketone group (—CO—), ester group (—C(O)O—) and cyano group (—CN). Preferably, the carbon-carbon double bond group is derived from one or more of α, β-unsaturated aldehyde, α, β-unsaturated ketone, α, β-unsaturated carboxylate ester and α, β-unsaturated nitrile, preferably from α, β-unsaturated carboxylate esters.

In one embodiment of the present application, the reactive acceptor may be one or more selected from α, β-unsaturated carboxylate esters represented by the following formula:

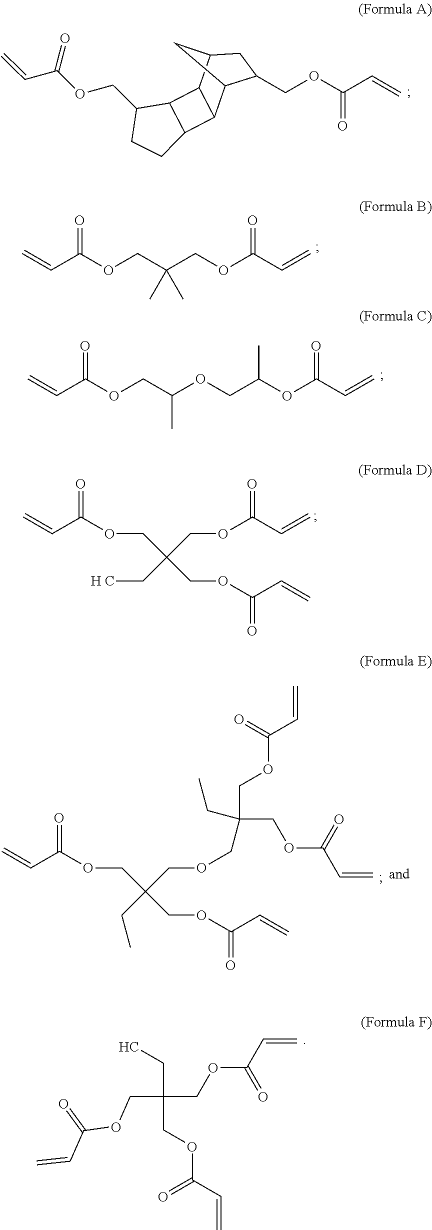

In a preferred embodiment of the present application, the reactive acceptor may be one or more selected fromα, β-unsaturated carboxylate esters represented by Formula A and Formula C.

In the Michael addition-curable compositions according to the present application, the amount of reactive acceptors as used can vary widely as desired. In some embodiments of the present application, the Michael addition-curable composition comprises, relative to the total weight of the primary agent of the Michael addition-curable composition, 20 to 48 wt % of reactive acceptors, preferably 30 to 45 wt % of reactive acceptors, which primary agent is consisted of the remaining components excluding the catalyst and the diluent.

### Catalyst

In addition to the above components, the Michael Addition Curable composition according to the present application comprises a catalyst for catalyzing the Michael Addition crosslinking reaction of the reactive acceptor and reactive donor.

In some embodiments of the present application, the catalyst is a latent base catalyst.

In an embodiment of the present application, the latent base catalyst described herein is a substituted carbonate salt having the structure of formula (II):

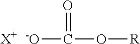

In Formula (II):
X⁺ is a non-acidic cation. Suitable examples include, without limitation, alkali metal ion, alkali-earth metal ion, ammonium ion, phosphonium ion, and the like. Preferably, X⁺ is a lithium, sodium, or potassium ion, and the like. More preferably, X⁺ is a quaternary ammonium ion or a phosphonium ion;
R is H, optionally substituted C1-C10 alkyl, C6-C12 aryl, C7-C14 aralkyl or combinations thereof. Preferably, R is an unsubstituted alkyl group having 1 to 4 carbon atoms. If the R group is substituted, the substituents are selected so as to not substantially interfere with the crosslinking reaction. In order to avoid interference with the action of the base catalyst, acidic substituents, such as for example, carboxylic acid substituents are present in only insubstantial amounts, or absent altogether.

In an embodiment, the latent base catalyst described herein is a compound with the general structure shown in Formula (II), wherein the cation X⁺ is linked with the carbonate group of Formula (II) in a single molecule, i.e. the latent base catalyst has the general structure shown in Formula (II-1):

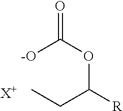

in the formula (II-1), R and X⁺ are defined as above.

In another embodiment, the latent base catalyst described herein is a compound of the general structure shown in Formula (II), wherein the group R is a polymer, and/or the cation X⁺ is a quaternary ammonium ion or a phosphonium ion.

In a preferred embodiment, the latent base catalyst described herein is preferably a quaternary alkyl ammonium carbonate. Suitable examples include, without limitation, tetrahexylammonium methyl carbonate, tetradecyl-trihexylammonium-methyl carbonate, tetradecylammonium methyl carbonate, tetrabutylammonium methylcarbonate, tetrabutylammonium ethylcarbonate, benzyltrimethylammonium methyl carbonate, or trihexylmethylammonium methyl carbonate or trioctylmethylammonium methyl carbonate, and mixtures or combinations thereof.

Preferably, the latent base catalyst described herein include tetrabutylammonium alkylcarbonate. Latent catalysts of this type are known in the art.

Without limiting to theory, it is believed that the latent base catalyst of Formula (II) functions by releasing carbon dioxide when the carbonate salt decomposes. This produces a strong base, i.e. a hydroxide, an alkoxy, or an aralkyloxy base. In a closed pot, this reaction takes place slowly, allowing for extended pot life. When the coating is applied and surface area increases, the base is regenerated quickly as carbon dioxide escapes from the surface, allowing for faster cure (i.e. drying and hardness development) of the coating. Accordingly, the use of a latent base catalyst of Formula (II) allows for optimal potlife, open time, and cure performance for the crosslinkable coating compositions described herein.

In another embodiment, the catalyst may also include conventional catalysts (i.e., non-latent catalysts) known to those skilled in the art that are different from the above-mentioned latent base catalysts, which may be used alone or in combination with the latent base catalyst described herein to accelerate the Michael addition reaction.

Examples of suitable non-latent catalysts include, without limitation, tetrabutyl ammonium hydroxide (TBAH), ammonium hydroxide, DBU (8-Diazabicyclo[5.4.0]undec-7-ene), DBN (1,5-Diazabicyclo[4.3,0]non-5-ene), and TMG (1,1,3,3-tetramethylguanidine).

Suitable additional examples of non-latent catalysts include, without limitation, salts of cations including non-acidic cations such as K+, Na+, Li+, or weakly acidic cations such as, for example, protonated species of strong organic bases such as, for example, DBU, DBN, TMG or TBAH and the like, paired with a basic anion X⁻ from an acidic X-Hgroup-containing compound, where X comprises N, P, O, S, C or Cl. Suitable examples of such non-latent catalyst may be tetrabutyl ammonium fluoride.

In one embodiment, the amount of catalyst used herein may vary depending on the nature of the composition. Preferably, the catalyst is present in an amount of 1.0 part by weight or more, preferably 1.4 parts by weight or more and not more than 10 parts by weight, preferably no more than 8 parts by weight and more preferably no more than 5 parts by weight, based on the solid amount of the catalyst relative to 100 parts by weight of the primary agent of the Michael Addition-curable composition that is consisted of other components than catalysts and diluents.

### Other Components

The Michael Addition-curable composition according to an embodiment of the present application may further comprise at least one solvent in order to adjust viscosity of the composition to obtain the desired processability.

In certain embodiments of the present application, the solvent comprises one or more of alcohols, such as methanol, isopropanol, isobutanol, n-propanol, n-butanol, 2-butanol, pentanol, tert-amyl alcohol, neopentyl alcohol, n-hexanol, ethylene glycol, and the like; esters such as ethyl acetate, butyl acetate, methoxypropyl acetate, isobutyl acetate, propylene glycol methyl ether acetate and the like; ketones such as methyl ethyl ketone, methyl n-amyl ketone, and the like; ethers such as ethylene glycol butyl ether, and the like; aliphatic solvents such as solvent oils, and the like; and aromatic and/or alkylated aromatic solvents such as toluene, xylene, and the like.

In a specific embodiment of the present application, the solvent includes one or more of isopropanol, propylene glycol methyl ether acetate, ethyl acetate and butyl acetate.

In an embodiment of the present application, the weight percentage of solvents may vary within a wide range. Relative to 100 parts by weight of the primary agent in the Michael addition curable composition, the amount of solvent preferably varies in the range of 0.1 parts by weight to 35 parts by weight, more preferably 10 parts by weight to 30 parts by weight, still more preferably in the range of 15 parts by weight to 30 parts by weight, and even more preferably in the range of 25 parts by weight to 30 parts by weight.

In an embodiment of the present application, the composition of the present application may optionally further comprise other additional additives commonly used in the composition, which additives do not adversely affect the composition or cured product obtained therefrom. Suitable additives comprise, for example, those that improve processing or manufacturing properties of the composition, enhance aesthetics of the composition or cured product obtained therefrom, or improve specific functional properties or characteristics of the composition or cured product obtained therefrom (such as adhesion to the substrate). The additives that may be included are, for example, selected from adhesion promoters, curing accelerators, open time regulators, pigments and fillers, surfactants, lubricants, defoamers, dispersants, UV absorbers, colorants, coalescing agents, thixotropic agents, antioxidants, stabilizers, preservatives, and fungicides for providing the required performance as needed. The content of each optional ingredient is preferably sufficient to achieve its intended purpose, but does not adversely affect the composition or cured product obtained therefrom.

### Michael Addition Curable Composition

According to embodiments of the present application, after components of the composition of the present application are mixed, the resulting mixture has a relatively long pot life and shows particularly excellent workability. In one embodiment of the present application, after components of the composition are mixed, the resulting mixture has a pot life of 6 hours or more, preferably of 7 hours or more, and more preferably of 8 hours or more, and even more preferably of 10 hours or more at 25 °C.

The Michael Addition-curable composition of the present application can be cured at an appropriate temperature according to needs, for example, materials of coated substrate. In some embodiments, curing is performed at room temperature, especially within a range of 20-40 °C and preferably within a range of 25-35 °C. In other embodiments, it can be cured under high temperature baking conditions, such as above 100 °C.

The Michael Addition curable composition of the present application can be cured for an appropriate period of time, which depends on curing temperature. In some embodiments of the present application, the Michael Addition Curable composition of the present application may achieve tack-free in 2 hours or less, preferably in 1.8 hours or less, more preferably in 1.5 hours or less at room temperature. In other embodiments according to the present application, the Michael addition-curable composition of the present application has a gel time of 25 minutes or longer, preferably 30 minutes or longer, more preferably 35 minutes or more at room temperature.

The Michael Addition curable compositions according to the embodiments of the present application are suitable for a variety of applications, and can be used for manufacture of coatings, adhesives, sealants, foams, elastomers, films, molded articles, or inks.

Prior to use, the Michael Addition-curable composition according to embodiments of the present application may be stored in various ways. In certain embodiments according to the present application, components of the Michael Addition curable composition, such as a reactive donor, a reactive acceptor, and a catalyst, are stored separately. In other embodiments of the present application, certain components of the Michael Addition curable composition may be pre-mixed, for example, a reactive donor and a reactive acceptor may be pre-mixed, and a catalyst may be stored separately, or a catalyst may be pre-mixed with a reactive donor or a reactive acceptor, and the remaining component is stored separately. Upon using, a reactive donor, a reactive acceptor, a catalyst and other components are simply mixed in a mixing vessel at a predetermined weight ratio. The mixed curable composition can be shaped using various methods familiar to those skilled in the art, such as by molding, coating, extrusion, and the like. The composition thus obtained can be cured to form a desired cured product. Therefore, the present application also relates to a cured product obtained and/or obtainable by the Michael Addition curable composition of the present application.

### Coating Composition

The Michael Addition curable composition according to the present application is particularly suitable for application of a coating composition in coating industry. Therefore, embodiments of the present application in still another aspect relates to a coating composition, comprising the Michael Addition curable composition according to the present application as a film-forming resin.

In certain embodiments, the coating compositions of the present application comprises:
a primary agent comprising at least one reactive donor capable of providing two or more nucleophilic carbanions, at least one reactive acceptor containing two or more carbon-carbon double bond groups, and optionally additional additives such as thickeners, wetting agents, leveling agents, antifoaming agents, dispersing agents, pH adjusters, mildew inhibitors, preservatives, or any combination thereof;
a catalyst comprising at least one catalyst for catalyzing the Michael addition crosslinking reaction of the reactive donor and the reactive acceptor; and
solvents, comprising isopropanol, propylene glycol methyl ether acetate, ethyl acetate, butyl acetate, or combinations thereof.

In some embodiments according to the present invention, when mixing components of the coating compositions of the present invention, the resulting mixture has an appropriate pot life showing particularly excellent workability. In one embodiment of the present invention, when mixing components of said coating composition, the resulting mixture has a pot life of 4-24 hours, preferably having a pot life of 6 to 18 hours, more preferably having a pot life of 8 hours to 18 hours at 25 °C.

In some embodiments according to the present invention, when the coating composition according to the present invention is applied at a wet coating thickness of 200 microns and dried for 1 day, the resulting cured coating has a chemical resistance of grade 4 or more, preferably having a chemical resistance of grade 5, as determined by ASTM F2250-method B.

In some embodiments according to the present invention, when the coating composition according to the present invention is applied at a wet coating thickness of 200 microns and dried for 1 day, the resulting cured coating has a hardness of 2B or higher, preferably with a hardness of B or higher, more preferably with a hardness of HB or higher, and still more preferably with a hardness of H or higher, said hardness being a pencil hardness according to standard ASTM D3363.

In some embodiments according to the present invention, when the coating composition according to the present invention is applied at a wet coating thickness of 200 microns and dried for 1 day, the resulting cured coating has a toughness of 10 mm or less, preferably having a toughness of 5 mm, as determined according to GB/T 1731-2020.

In an embodiment in which the Michael Addition curable composition according to the present application is used as a coating composition, the composition can be applied in a variety of ways that are familiar to those skilled in the art, including spraying (e.g., air assisted, airless or electrostatic spraying), brushing, rolling, flooding and dipping. In an embodiment of the present application, the mixed coating composition is coated by spraying. The coating composition can be applied in various wet film thickness. In an embodiment of the present application, the coating composition is applied in such a wet film thickness in the range of about 100 to about 400 μm, preferably in the range of about 100 to 200 μm. The applied coating may be cured by air drying at room temperature or by accelerating drying with various drying devices e.g., ovens that are familiar to those skilled in the art.

### Coated Articles

The present application in another aspect provided a coated article comprising a substrate having at least one major surface; and a cured coating formed from the coating composition of the present application that is directly or indirectly applied on the major surface.

According to the invention, the substrate has at least one, preferably two, major surfaces that are opposite one another. As used herein, “major surface” is a surface defined by the lengthwise and widthwise dimensions of the substrate for providing decoration. Preferably, the major surface of substrate may contain polar groups such as hydroxyl groups, amino groups, mercapto groups, and the like for promoting adhesion. The hydroxyl group on the surface of substrate may be originated from the substrate itself, such as from cellulose when the substrate is a wooden substrate or may be introduced on the surface of substrate by performing surface treatment on the major surface of substrate, for example, by corona treatment.

According to the present application, the coating composition described herein may be applied on a variety of substrates. Suitable examples include, without limitation, natural and engineered buildings and building materials, freight containers, flooring materials, walls, furniture, other building materials, motor vehicles, motor vehicle components, aircraft components, trucks, rail cars and engines, bridges, water towers, cell phone tower, wind towers, radio towers, lighting fixtures, statues, billboard supports, fences, guard rails, tunnels, pipes, marine components, machinery components, laminates, equipment components, appliances, and packaging. Exemplary substrates include, without limitation, wood, metal, plastic, ceramic, cementitious board or any combination thereof.

### Preparation of Modified Epoxy Resin

As mentioned above, the inventors of the present application have succeeded for the first time in synthesizing a modified epoxy resin using a novel method in which the —C(O)—CH₂—C(O)-moiety is incorporated not only into a backbone structure of the epoxy resin, but also into pendent chains on the backbone of the epoxy resin. Accordingly, another aspect of the present invention provides a new process for preparing a modified epoxy resin, said process comprising the steps of:
(i) subjecting at least one epoxy resin to a ring-opening reaction with malonic acid at a temperature below 130 °C, in the presence of at least one catalyst, so as to reach an acid value close to 0 mg KOH/g, thereby introducing secondary hydroxyl groups into the at least one epoxy resin to form a reaction product; and
(ii) subjecting the reaction product obtained in step i) to a transesterification reaction with at least one alkyl acetoacetate to form the modified epoxy resin,
wherein the modified epoxy resin comprises at least one first —C(O)—CH₂—C(O)-moiety and at least one second —C(O)—CH₂—C(O)-moiety, in which the at least one first —C(O)—CH₂—C(O)-moiety is covalently incorporated into at least one epoxy resin backbone, and the at least one second —C(O)—CH₂—C(O)-moiety is covalently bonded to the pendant of the at least one epoxy resin backbone.

In a preferred embodiment of the above process, said ring opening reaction of the epoxy resin with malonic acid is carried out at a temperature of 90-120 °C.

In a preferred embodiment of the above process, said catalyst is selected from quaternary ammonium salts, quaternary phosphonium salts or combinations thereof, preferably comprising tetraalkylammonium bromide.

The following examples describe the present application in more detail, which are for illustrative purposes only, since various modifications and changes will be apparent to those skilled in the art from the scope of the present application. Unless otherwise indicated, all parts, percentages, and ratios reported in the following examples are on a weight basis and all reagents used in the examples are commercially available and may be used without further treatment.

### EXAMPLES

### Test Method

Gel time: At 25.5 °C, a sample of the Michael addition-curable composition or coating composition was placed open in a glass bottle, and then measured with IWATA NK-2 to determine the time required for its viscosity to reach 2 times the initial viscosity.

Track-free time: At 25.5 °C, a sample of the Michael addition-curable composition or coating composition was applied to the surface to be coated to form a 200 μm wet film, and then the time required for the resulting film to reach not to stick hands was measured according to GB1728-2020.

Hardness: At 25.5 °C, after 200 μm wet film was applied and then dried for 7 days, the resulting film was measured according to standard ASTM D3363 for its hardness.

Toughness: At 25.5 °C, after 200 μm wet film was applied and then dried for 7 days, the resulting film was measured by bending with a shaft rod according to GB/T 1731-2020, in which the toughness is measured by a diameter of the shaft rod. Generally, the smaller the diameter of the rod, the better the toughness of the resulting coating is.

Chemical Resistance: At 25.5 °C, after 200 μm wet film was applied and then dried for 7 days, the resulting film was subjected to acetic acid for 1 hour, soda ash (50 g/L) for 2 hours, alcohol (70%) for 1 hour, cold water for 24 hours, boiling water for 30 minutes and/or 5 cycles of cold verification according to ASTM F2250-Test Method B to evaluate its chemical resistance. Finally, an integrity of the resulting coating was determined. Chemical resistance was usually graded on a scale of 0-5, where 5=coating was intact, free of stains and delamination (best), 4=coating stains were barely noticeable, 3=coating stains can be clearly identified, 2=coating was discolored and had blistering, softening, and the like, and 0=coating had large bubbles, tendency to delaminate, and the like (worst).

### Reactive Donor

### Modified Epoxy Resin A1:

At room temperature, 702.50 g of epoxy resin (specifically epichlorohydrin-bisphenol A epoxy resin, a liquid epoxy resin at room temperature with an epoxy equivalent weight of 180-190 g/eq as measured by ASTM 1652) and 6.93 g of catalyst (tetrabutylammonium bromide) were loaded into a four-necked flask equipped with a thermometer, a top stirrer, a gas inlet, and a reflux device. N₂ protection was provided by supplying N₂ gas through the gas inlet. The resulting mixture was then slowly heated to 80 °C and 183.85 g of malonic acid was slowly added, controlling exotherm in the range of 80-100 °C. After the malonic acid was added, it was kept at 100 °C until a solid acid value approached 0 mgKOH/g.

When the above acid value approached 0, 498.16 g of tert-butyl acetoacetate (t-BAA) was added to the mixture. The reaction mixture was then slowly heated to about 110 °C, the distillate (tert-butanol) was collected and then the resulting mixture was held at that temperature until the distillation temperature did not exceed 78 °C. Under these conditions (distillation temperature <=78 °C), the temperature of the mixture was raised to 180 °C. When the temperature of the mixture reached 180 °C, it was held at that temperature until the distillation temperature was below 60 °C. The mixture was then cooled to below 120 °C and mixed with 428.56 g of n-butyl acetate (n-BA). The solids content was about 72%, the molecular weight was from 500 to 5000, the polydispersity index was from 1.1 to 3, and the molar ratio of —C(O)—CH₂—C(O)-moiety derived from malonic acid to —C(O)—CH₂—C(O)-moiety derived from t-BAA was 0.56. Based on the liquid resin, the final active hydrogen (—C(O)—CH₂—C(O)-moiety) equivalent was about 165.82 g/mol.

### Modified Epoxy Resin A2:

At room temperature, 789.80 g of epoxy resin (specifically, bisphenol-A type solid epoxy resin at room temperature with an epoxy equivalent weight of 450-500 g/eq as measured by ASTM 1652), 83.19 g of n-butyl acetate (n-BA), and 6.93 g of catalyst (tetrabutylammonium bromide) were loaded into a four-necked flask equipped with a thermometer, a top stirrer, a gas inlet, and a reflux device. N₂ protection was provided by supplying N₂ gas through the gas inlet. The resulting mixture was then slowly heated to 100 °C and 72.71 g of malonic acid was slowly added, controlling exotherm in the range of 100-110 °C. After the malonic acid was added, it was kept at 100 °C until a solid acid value approached 0 mgKOH/g.

When the above acid value approached 0, 500.90 g of tert-butyl acetoacetate (t-BAA) was added to the mixture. The reaction mixture was then slowly heated to about 110 °C, the distillate (tert-butanol) was collected and then the resulting mixture was held at that temperature until the distillation temperature did not exceed 78 °C. Under these conditions (distillation temperature <=78 °C), the temperature of the mixture was raised to 180 °C. When the temperature of the mixture reached 180 °C, it was held at that temperature until the distillation temperature was below 60 °C. The mixture was then cooled to below 120 °C and mixed with 339.61 g of n-butyl acetate (n-BA). The solids content was about 72%, the molecular weight was from 500 to 5000, the polydispersity index was from 1.1 to 3, and the molar ratio of —C(O)—CH₂—C(O)-moiety derived from malonic acid to —C(O)—CH₂—C(O)-moiety derived from t-BAA was 0.22. Based on the solid resin, the final active hydrogen (—C(O)—CH₂—C(O)-moiety) equivalent was about 202.49 g/mol.

### Modified Epoxy Resin A3:

At room temperature, 875.13 g of epoxy resin (specifically, solid epoxy resin at room temperature with an epoxy equivalent weight of 600-650 g/eq as measured by ASTM 1652), 69.80 g of n-butyl acetate (n-BA), and 7.49 g of catalyst (tetrabutylammonium bromide) were loaded into a four-necked flask equipped with a thermometer, a top stirrer, a gas inlet, and a reflux device. N₂ protection was provided by supplying N₂ gas through the gas inlet. The resulting mixture was then slowly heated to 100 °C and 61.00 g of malonic acid was slowly added, controlling exotherm in the range of 100-110 °C. After the malonic acid was added, it was kept at 100 °C until a solid acid value approached 0 mgKOH/g.

When the above acid value approached 0, 420.28 g of tert-butyl acetoacetate (t-BAA) was added to the mixture. The reaction mixture was then slowly heated to about 110 °C, the distillate (tert-butanol) was collected and then the resulting mixture was held at that temperature until the distillation temperature did not exceed 78 °C. Under these conditions (distillation temperature <=78 °C), the temperature of the mixture was raised to 180 °C. When the temperature of the mixture reached 180 °C, it was held at that temperature until the distillation temperature was below 60 °C. The mixture was then cooled to below 120 °C and mixed with 358.80 g of n-butyl acetate (n-BA). The solids content was about 72%, the molecular weight was from 500 to 5000, the polydispersity index was from 1.1 to 3, and the molar ratio of —C(O)—CH₂—C(O)-moiety derived from malonic acid to —C(O)—CH₂—C(O)-moiety derived from t-BAA was 0.22. Based on the solid resin, the final active hydrogen (—C(O)—CH₂—C(O)-moiety) equivalent was about 247.16 g/mol.

### Reactive Acceptor

TABLE 1
various reactive acceptors

| Reactive | |
|---|---|
| Acceptors | Structure Formula |
| B1 | DPGDA Dipropylene glycol diacrylate 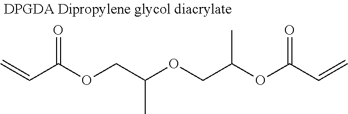 [SMILES: C=CC(=O)OCC(C)OCC(C)OC(=O)C=C] |
| B2 | 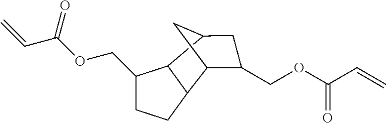 [SMILES: C=CC(=O)OCC1CC2CC1C1CCC(COC(=O)C=C)C21] |

### Catalyst

Catalysts C1: commercial available blocked catalyst (strong base which is blocked with di-ethyl carbonate).

Catalysts C1: 30% aqueous solution of tetrabutylammonium fluoride

### Coating Composition

### Example 1 Michael Addition Curable Composition

The ingredients of Component A in the amounts shown in Table 2 below were mixed to form Component A, and then Component A, Component B and Component C were mixed in the amounts shown in Table 2 below, thereby forming coating compositions 1-1 to 1-12 suitable for forming Michael addition cured coatings.

The compositions prepared in the examples shown in the following Tables 1 were respectively applied to the test substrate with a wet coating thickness of 200 microns, and cured at room temperature. The time required for curing was recorded. The indicator of “curing” here is that the coating reaches not to stick hands, which can also be called “track-free time”. The resulting coatings were measured according to the test section for their hardness, toughness and chemical resistance.

TABLE 2
Components of compositions 1-1 to 1-6 and the resulting coating performances

| | | Composition | Composition | Composition | Composition | Composition | Composition |
|---|---|---|---|---|---|---|---|
| | | 1-1 | 1-2 | 1-3 | 1-4 | 1-5 | 1-6 |
| Component A | | | | | | | |
| Reactive | A1/g | 55.2 | | | 49.8 | | |
| donor | A2/g | | 59.8 | | | 54.5 | |
| | A3/g | | | 64.1 | | | 59.1 |
| Reactive | B1/g | 40.3 | 35.7 | 31.4 | | | |
| acceptor | B2/g | | | | 45.7 | 41.0 | 36.4 |
| Butyl acetate/g | | 4.5 | 4.5 | 4.5 | 4.5 | 4.5 | 4.5 |
| Component B | | | | | | | |
| Catalyst C1/g | | 3.6 | 3.6 | 3.6 | 3.6 | 3.6 | 3.6 |
| Component C | | | | | | | |
| n-butyl acrylate | | 30 | 30 | 30 | 30 | 30 | 30 |
| Track-free time/min | | 90 | 90 | 90 | 90 | 90 | 90 |
| Toughness | | 5 mm | 5 mm | 5 mm | 5 mm | 5 mm | 5 mm |
| Hardness | | B | HB | HB | HB | H | H |
| Chemical resistance | | 5 | 5 | 5 | 5 | 5 | 5 |

Components of compositions 1-7 to 1-12 and the resulting coatings performances

| | | Composition | Composition | Composition | Composition | Composition | Composition |
|---|---|---|---|---|---|---|---|
| | | 1-7 | 1-8 | 1-9 | 1-10 | 1-11 | 1-12 |
| Component A | | | | | | | |
| Reactive | A1/g | 55.2 | | | 49.8 | | |
| donor | A2/g | | 59.8 | | | 54.5 | |
| | A3/g | | | 64.1 | | | 59.1 |
| Reactive | B1/g | 40.3 | 35.7 | 31.4 | | | |
| acceptor | B2/g | | | | 45.7 | 41.0 | 36.4 |
| Butyl acetate/g | | 4.5 | 4.5 | 4.5 | 4.5 | 4.5 | 4.5 |
| Component B | | | | | | | |
| Catalyst C2/g | | 3.6 | 3.6 | 3.6 | 3.6 | 3.6 | 3.6 |
| Component C | | | | | | | |
| n-butyl acrylate | | 30 | 30 | 30 | 30 | 30 | 30 |
| Track-free time/min | | 90 | 90 | 90 | 90 | 90 | 90 |
| Toughness | | 5 mm | 5 mm | 5 mm | 5 mm | 5 mm | 5 mm |
| Hardness | | 2B | B | B | B | HB | HB |
| Chemical resistance | | 5 | 5 | 5 | 5 | 5 | 5 |

As can be seen from the results in Table 2 above, the modified epoxy resins according to the present invention can be combined with a variety of reactive acceptors and different catalysts to form a Michael addition-curable system, and the resulting Michael addition-curable compositions can be cured at room temperature. In addition, the modified epoxy resins first successfully synthesized by the inventors of the present application using a ring opening reaction with both active hydrogens derived from malonic acid and active hydrogens derived from alkyl acetoacetate are also suitable for formulation of Michael additive curable compositions with certain catalysts and the resultant curable compositions similarly exhibit appropriate curing speeds, and the resultant coatings similarly exhibit appropriate toughness, hardness and chemical resistance.

### EMBODIMENTS

The following embodiments are contemplated. All combinations of features and embodiments are contemplated.

Embodiment 1: A Michael Addition curable composition, comprising: at least one reactive donor capable of providing two or more nucleophilic carbanions; at least one reactive acceptor comprising two or more carbon-carbon double bonds; and at least one catalyst for catalyzing a Michael Addition crosslinking reaction between the at least one reactive donor and the at least one reactive acceptor, wherein the at least one reactive donor comprises at least one epoxy resin-based reactive donor derived from at least one epoxy resin; and wherein the at least one epoxy resin-based reactive donor comprises at least one first —C(O)—CH₂—C(O)-moiety and at least one second —C(O)—CH₂—C(O)-moiety, in which the at least one first —C(O)—CH₂—C(O)-moiety is covalently incorporated into at least one epoxy resin backbone, and the at least one second —C(O)—CH₂—C(O)-moiety is covalently bonded to pendant chains on the at least one epoxy resin backbone.

Embodiment 2: An embodiment of Embodiment 1, wherein a molar ratio of the at least one first —C(O)—CH₂—C(O)-moiety covalently incorporated into the at least one epoxy resin backbone to the at least one second —C(O)—CH₂—C(O)-moiety covalently bonded to pendant chain on the at least one epoxy resin backbone is less than 1:1 but greater than 1:4, preferably in the range of 1:1.5-2.5, more preferably in the range of 1:1.8-2.2.

Embodiment 3: An embodiment of any of Embodiments 1-2, wherein the at least one first —C(O)—CH₂—C(O)-moiety covalently incorporated into the at least one epoxy resin backbone is derived from malonic acid.

Embodiment 4: An embodiment of any of Embodiments 1-3, wherein the at least one second —C(O)—CH₂—C(O)-moiety covalently bonded to pendant chains on the at least one epoxy resin backbone is derived from alkyl acetoacetates.

Embodiment 5: An embodiment of any of Embodiments 1-4, wherein the at least one epoxy resin backbone comprises at least one aromatic epoxy backbone.

Embodiment 6: An embodiment of any of Embodiments 1-5, wherein at least one epoxy resin backbone comprises at least one ether oxygen bond (—O—).

Embodiment 7: An embodiment of any of Embodiments 1 to 6, wherein the at least one epoxy resin comprises bisphenol A epoxy resin, bisphenol F epoxy resin, novolac epoxy resin, or combinations thereof.

Embodiment 8: An embodiment of any of Embodiments 1 to 7, wherein the at least one epoxy resin-based reactive donor is obtained by: (i) subjecting at least one epoxy resin to a ring-opening reaction with malonic acid at a temperature below 130 °C, in the presence of at least one catalyst to reach an acid value close to 0 mg KOH/g, thereby introducing secondary hydroxyl groups into the at least one epoxy resin, to form a reaction product; and (ii) subjecting the reaction product obtained in step i) to a transesterification reaction with at least one alkyl acetoacetate to form the at least one epoxy resin-based reactive donor.

Embodiment 9: An embodiment of Embodiment 8, wherein the at least one alkyl acetoacetate comprises at least one C1-C8 alkyl acetoacetate.

Embodiment 10: An embodiment of any of Embodiments 1 to 9, wherein the at least one epoxy resin-based reactive donor has a polydispersity index in the range of 1.0 to 3.5, preferably in the range of 1.0 to 3.2, more preferably in the range of 1.1 to 3.0, as determined by GPC.

Embodiment 11: An embodiment of any of Embodiments 1 to 10, wherein the at least one epoxy resin-based reactive donor has a weight average molecular weight in the range of 500 g/mol to 15000 g/mol, preferably in the range of 500 g/mol to 10000 g/mol, more preferably in the range of 500 g/mol to 8000 g/mol and even more preferably in the range of 500 g/mol to 5000 g/mol as determined by GPC.

Embodiment 12: An embodiment of any of Embodiments 1 to 11, wherein the at least one epoxy resin-based reactive donor has a glass transition temperature of 25 °C or higher, more preferably in the range of 25 °C to 40 °C.

Embodiment 13: An embodiment of any of Embodiments 1-12, wherein a polymer formed by homopolymerization of the at least one reactive acceptor has a Tg of at least 100 °C.

Embodiment 14: An embodiment of any of Embodiments 1-13, wherein the two or more carbon-carbon double bonds have the structure of Formula I below:

—C═C—CX (Formula I)

wherein CX represents any one of an aldehyde group (—CHO), a keto group (—CO—), an ester group (—C(O)O—), and a cyano group (—CN).

Embodiment 15: An embodiment of any of Embodiments 1-14, further comprising at least one solvent, wherein the at least one solvent is one or more selected from isopropanol, propylene glycol methyl acetate, ethyl acetate and butyl acetate.

Embodiment 16: An embodiment of any of Embodiments 1 to 15 used to manufacture coatings, adhesives, sealing agents, foaming materials, films, molded products or inks.

Embodiment 17: A coating composition, comprising the Michael Addition curable composition according to any of Embodiments 1 to 16 as a film-forming resin.

Embodiment 18: An embodiment of Embodiment 17, wherein when the coating composition is applied at a wet coat thickness of 200 microns and dried for 1 day, the resulting cured coating has a chemical resistance of grade 4 or more, as determined by ASTM F2250-method B.

Embodiment 19: An embodiment of Embodiment 19, wherein, when components of the coating composition are mixed, the resulting mixture has a pot life of 4-24 hours.

Embodiment 20: A coated article comprising: a substrate having at least one major surface; and a cured coating formed from the coating composition according to any one of Embodiemtns 17-19 that is at least partially directly or indirectly applied on the major surface.

Embodiment 21: An embodiment of Embodiment 20, wherein the substrate comprises wood, metal, plastic, ceramic, cementitious board, or combination thereof.

Embodiment 22: A process for preparing a modified epoxy resin comprising the steps of: (i) subjecting at least one epoxy resin to a ring-opening reaction with malonic acid at a temperature below 130 °C, in the presence of at least one catalyst, so as to reach an acid value close to 0 mg KOH/g, thereby introducing secondary hydroxyl groups into the at least one epoxy resin to form a reaction product; and (ii) subjecting the reaction product obtained in step i) to a transesterification reaction with at least one alkyl acetoacetate to form the modified epoxy resin, wherein the modified epoxy resin comprises at least one first —C(O)—CH₂—C(O)-moiety and at least one second —C(O)—CH₂—C(O)-moiety, in which the at least one first —C(O)—CH₂—C(O)-moiety is covalently incorporated into at least one epoxy resin backbone, and the at least one second —C(O)—CH₂—C(O)-moiety is covalently bonded to pendant chains on the at least one epoxy resin backbone.

Embodiment 23: An embodiment of Embodiment 22, wherein the ring-opening reaction of the at least one epoxy resin and malonic acid is carried out at a temperature of 90-120 °C.

Embodiment 24: An embodiment of any of Embodiments 22-23, wherein the at least one catalyst is selected from quaternary ammonium salts, quaternary phosphonium salts, or combinations thereof, preferably tetraalkylammonium bromides

While the invention has been described with respect to a number of embodiments and examples, those skilled in the art, having benefit of this invention, will appreciate that other embodiments can be devised which do not depart from the scope and spirit of the invention as disclosed herein.

What is claimed is:

1. A Michael Addition curable composition, comprising:
at least one reactive donor capable of providing two or more nucleophilic carbanions;
at least one reactive acceptor comprising two or more carbon-carbon double bonds; and
at least one catalyst for catalyzing a Michael Addition crosslinking reaction between the at least one reactive donor and the at least one reactive acceptor,
wherein the at least one reactive donor comprises at least one epoxy resin-based reactive donor derived from at least one epoxy resin; and
wherein the at least one epoxy resin-based reactive donor comprises at least one first —C(O)—CH₂—C(O)-moiety and at least one second —C(O)—CH₂—C(O)-moiety, in which the at least one first —C(O)—CH₂—C(O)-moiety is covalently incorporated into at least one epoxy resin backbone, and the at least one second —C(O)—CH₂—C(O)-moiety is covalently bonded to pendant chains on the at least one epoxy resin backbone.

2. The Michael Addition curable composition according to claim 1, wherein a molar ratio of the at least one first —C(O)—CH₂—C(O)-moiety covalently incorporated into the at least one epoxy resin backbone to the at least one second —C(O)—CH₂—C(O)-moiety covalently bonded to pendant chain on the at least one epoxy resin backbone is less than 1:1 but greater than 1:4, preferably in the range of 1:1.5-2.5, more preferably in the range of 1:1.8-2.2.

3. The Michael Addition curable composition according to claim 1, wherein the at least one first —C(O)—CH₂—C(O)-moiety covalently incorporated into the at least one epoxy resin backbone is derived from malonic acid.

4. The Michael Addition curable composition according to claim 1, wherein the at least one second —C(O)—CH₂—C(O)-moiety covalently bonded to pendant chains on the at least one epoxy resin backbone is derived from alkyl acetoacetates.

5. The Michael addition-curable composition according to claim 1, wherein the at least one epoxy resin backbone comprises at least one aromatic epoxy backbone.

6. The Michael addition-curable composition according to claim 1, wherein at least one epoxy resin backbone comprises at least one ether oxygen bond (—O—).

7. The Michael addition-curable composition according to claim 1, wherein the at least one epoxy resin comprises bisphenol A epoxy resin, bisphenol F epoxy resin, novolac epoxy resin, or combinations thereof.

8. The Michael addition-curable composition according to claim 1, wherein the at least one epoxy resin-based reactive donor is obtained by:
(i) subjecting at least one epoxy resin to a ring-opening reaction with malonic acid at a temperature below 130 °C, in the presence of at least one catalyst to reach an acid value close to 0 mg KOH/g, thereby introducing secondary hydroxyl groups into the at least one epoxy resin, to form a reaction product; and
(ii) subjecting the reaction product obtained in step i) to a transesterification reaction with at least one alkyl acetoacetate to form the at least one epoxy resin-based reactive donor.

9. The Michael addition-curable composition according to claim 8, wherein the at least one alkyl acetoacetate comprises at least one C1-C8 alkyl acetoacetate.

10. The Michael addition-curable composition according to claim 1, wherein the at least one epoxy resin-based reactive donor has a polydispersity index in the range of 1.0 to 3.5, preferably in the range of 1.0 to 3.2, more preferably in the range of 1.1 to 3.0, as determined by GPC.

11. The Michael addition-curable composition according to claim 1, wherein the at least one epoxy resin-based reactive donor has a weight average molecular weight in the range of 500 g/mol to 15000 g/mol, preferably in the range of 500 g/mol to 10000 g/mol, more preferably in the range of 500 g/mol to 8000 g/mol and even more preferably in the range of 500 g/mol to 5000 g/mol as determined by GPC.

12. The Michael addition-curable composition according to claim 1, wherein the at least one epoxy resin-based reactive donor has a glass transition temperature of 25 °C or higher, more preferably in the range of 25 °C to 40 °C.

13. The Michael Addition curable composition according to claim 1, wherein a polymer formed by homopolymerization of the at least one reactive acceptor has a Tg of at least 100 °C.

14. The Michael Addition curable composition according to claim 1, wherein the two or more carbon-carbon double bonds have the structure of Formula I below:
—C═C—CX (Formula I)
wherein CX represents any one of an aldehyde group (—CHO), a keto group (—CO—), an ester group (—C(O)O—), and a cyano group (—CN).

15. The Michael Addition curable composition according to claim 1, further comprising at least one solvent, wherein the at least one solvent is one or more selected from isopropanol, propylene glycol methyl acetate, ethyl acetate and butyl acetate.

16. The Michael Addition curable composition according to claim 1 used to manufacture coatings, adhesives, sealing agents, foaming materials, films, molded products or inks.

17. A coating composition, comprising the Michael Addition curable composition according to claim 1 as a film-forming resin.

18. The coating composition according to claim 17, wherein when the coating composition is applied at a wet coat thickness of 200 microns and dried for 1 day, the resulting cured coating has a chemical resistance of grade 4 or more, as determined by ASTM F2250-method B.

19. The coating composition according to claim 18, wherein, when components of the coating composition are mixed, the resulting mixture has a pot life of 4-24 hours.

20. A coated article comprising
a substrate having at least one major surface; and
a cured coating formed from the coating composition according to claim 17 that is at least partially directly or indirectly applied on the major surface.

21. The coated article according to claim 20, wherein the substrate comprises wood, metal, plastic, ceramic, cementitious board, or combination thereof.

22. A process for preparing a modified epoxy resin comprising the steps of:
(i) subjecting at least one epoxy resin to a ring-opening reaction with malonic acid at a temperature below 130 °C, in the presence of at least one catalyst, so as to reach an acid value close to 0 mg KOH/g, thereby introducing secondary hydroxyl groups into the at least one epoxy resin to form a reaction product; and
(ii) subjecting the reaction product obtained in step i) to a transesterification reaction with at least one alkyl acetoacetate to form the modified epoxy resin,
wherein the modified epoxy resin comprises at least one first —C(O)—CH₂—C(O)-moiety and at least one second —C(O)—CH₂—C(O)-moiety, in which the at least one first —C(O)—CH₂—C(O)-moiety is covalently incorporated into at least one epoxy resin backbone, and the at least one second —C(O)—CH₂—C(O)-moiety is covalently bonded to pendant chains on the at least one epoxy resin backbone.

23. The process of claim 22, wherein the ring-opening reaction of the at least one epoxy resin and malonic acid is carried out at a temperature of 90-120 °C.

24. The process of claim 22, wherein the at least one catalyst is selected from quaternary ammonium salts, quaternary phosphonium salts, or combinations thereof, preferably tetraalkylammonium bromides.
